(19) United States
(12) Patent Application Publication
(10) Pub. No.: US 2026/0244490 A1
(43) Pub. Date: Aug. 20, 2026

(54) METHOD, APPARATUS AND DEVICE, MEDIUM AND PROGRAM PRODUCT FOR TASK NAVIGATION

(71) Applicant: Beijing Zitiao Network Technology Co., Ltd., Beijing (CN)

(72) Inventors: Yitao Tang, Beijing (CN); Yiping Kong, Beijing (CN)

(21) Appl. No.: 19/447,975

(22) Filed: Jan. 13, 2026

(30) Foreign Application Priority Data
Jan. 13, 2025 (WO) PCT/CN2025/072100

(51) Int. Cl. G06F 9/48; G06F 9/451

(52) U.S. Cl. CPC G06F 9/4881; G06F 9/451; G06F 9/485

(57) ABSTRACT

The embodiments of the disclosure relate to a method, an apparatus, a device, a medium, and a program product for task navigation. The method includes: presenting an indication of at least one task scenario in a first region of a first page, each task scenario including at least one task executable in the application, and execution of each task being based on at least one function provided by the application; presenting, in response to selection of a target task scenario from the at least one task scenario, guidance information corresponding to at least one target task included in the target task scenario in the first region; and presenting, in response to a selection of the first task from the at least one target task, presenting an operation interface related to the first task in a second region of the first page while maintaining the presentation of the guidance information.

### CROSS REFERENCE

This application claims priority to PCT Application No. PCT/CN2025/072100, filed on Jan. 13, 2025 and entitled “METHOD, APPARATUS AND DEVICE, MEDIUM AND PROGRAM PRODUCT FOR TASK NAVIGATION”, the entirety of which is incorporated herein by reference.

### FIELD

Example embodiments of the disclosure generally relate to the field of computers, and in particular, to a method, an apparatus, a device, a computer-readable storage medium, and a computer program product for task navigation.

### BACKGROUND

With the rapid development of digital information at present, the Internet has become an indispensable tool for people to obtain knowledge and carry out various activities. Internet information is presented to a user through a page. With the increasing complexity and diversification of Internet content, the importance of page navigation becomes increasingly prominent. When the user needs to perform a task through an application, clear page navigation can help the user to improve task execution efficiency. Thus, the task navigation of the desired page can meet the user's requirements to facilitate finding tasks and performing tasks.

### SUMMARY

In a first aspect of the disclosure, a method for task navigation is provided. The method includes: presenting an indication of at least one task scenario in a first region of a first page, each of the at least one task scenario including at least one task executable in the application, and the execution of each of the at least one task being based on at least one function provided by the application; presenting, in response to selection of a target task scenario from the at least one task scenario, guidance information corresponding to at least one target task included in the target task scenario in the first region; and presenting, in response to a selection of a first task from the at least one target task, an operation interface related to the first task in a second region of the first page while maintaining presentation of the guidance information.

In a second aspect of the disclosure, an apparatus for task navigation is provided. The apparatus includes: a scenario indication presenting module configured to present an indication of at least one task scenario in a first region of a first page, each of the at least one task scenario including at least one task executable in an application, and execution of each of the at least task being based on at least one function provided by the application; a guidance information presenting module configured to present, in response to a selection of a target task scenario from the at least one task scenario, guidance information corresponding to at least one target task included in the target task scenario in the first region; and an operation interface presenting module configured to present, in response to a selection of a first task from the at least one target task, an operation interface related to the first task in a second region of the first page while maintaining presentation of the guidance information.

In a third aspect of the disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the disclosure, a non-transitory computer-readable storage medium is provided. The computer-readable storage medium has computer instructions stored thereon, which are executable by a processor to implement the method of the first aspect.

In a fifth aspect of the disclosure, a computer program product is provided. The computer program product includes a computer program, wherein the computer program, when executed by a processor, implements the method according to the first aspect of the disclosure.

It should be understood that the content described in this content section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the disclosure may be implemented;

FIGS. 2A-2D illustrate schematic diagrams of example page structures according to some embodiments of the disclosure;

FIGS. 3A-3E illustrate example interfaces according to some embodiments of the disclosure;

FIG. 4 illustrates a flowchart of an example process for task navigation according to some embodiments of the disclosure;

FIG. 5 illustrates a schematic structural block diagram of an example apparatus for task navigation according to some embodiments of the disclosure; and

FIG. 6 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of a user, acquisition and/or use of data, and the like. These aspects all follow the corresponding laws and regulations and related regulations. In the embodiments of the disclosure, all data is collected, obtained, treated, processed, forwarded, used, etc., all of which are performed on the premise that the user knows and confirms. Accordingly, when implementing the embodiments of the disclosure, a type, a usage scope, a usage scenario, and the like of the data or information that may be involved should be notified to the user and obtain the authorization of the user in an appropriate manner according to the relevant laws and regulations. The specific notification and/or authorization manner may vary according to actual situations and application scenarios, and the scope of the disclosure is not limited in this regard.

According to the solutions in the present specification and the embodiments, for example, personal information processing is involved, processing may be performed on the premise of having a legality basis (for example, obtaining consent from a subject of the personal information, or necessary for performing a fulfillment contract), and processing may be only performed within a specified or agreed range. In the case that the user rejects personal information other than necessary information required by the basic function, a basic function for the user would be affected.

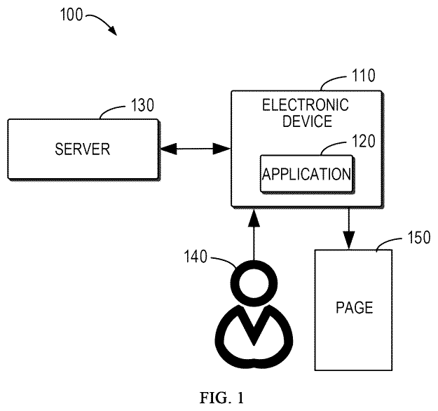

FIG. 1 illustrates a schematic diagram of an example environment 100 in which embodiments of the disclosure may be implemented. As shown in FIG. 1, the example environment 100 may include an electronic device 110.

In this example environment 100, the electronic device 110 may run an application 120 that supports interface interaction. An application 120 may be any suitable type of application for interface interaction, examples of which may include, but are not limited to, various websites, work systems, tool applications, social applications, or other suitable applications. A user 140 may interact with the application 120 via the electronic device 110 and/or its attachment device.

In the environment 100 of FIG. 1, if the application 120 is in an active state, the electronic device 110 may present a page 150 for supporting the interface interaction through the application 120.

In some embodiments, the electronic device 110 communicates with a server 130 to implement supply of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for the user (such as a “wearable” circuit, etc.).

The server 130 may be a standalone physical server, may be a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenarios in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this regard. In an embodiment of the disclosure, the server 130 and the electronic device 110 may implement signaling interaction through the communication connection between the server 130 and the electronic device 110.

It should be understood that the structures and functions of the various elements in the environment 100 are described for illustrative purposes only and do not imply any limitation to the scope of the disclosure.

As mentioned briefly above, when the user needs to perform a task through an application, a clear page navigation may facilitate the user to improve the task execution efficiency. However, most of the applications currently define their information architecture and main navigation according to entity relationships. Usually, a module in the navigation is named with names of entities of the application, and a corresponding page shows is a list page corresponding to instances.

While the overall structure of an application may be interpreted clearly with an entity as a navigation module, it is obscure for a user about what they specifically need to do anything, or what tasks can be performed, and the user is required to spend more time to explore by himself. This brings inconvenience for the user to find tasks and perform tasks.

In view of this, embodiments of the disclosure provide a solution for task navigation. According to the solution, an indication of at least one task scenario is presented in a first region of a first page, each task scenario includes at least one task executable in an application, and execution of each task is based on at least one function provided by the application. In response to a selection of the target task scenario from the at least one task scenario, guidance information corresponding to the at least one target task included in the target task scenario is presented in the first region. In response to a selection of the first task from the at least one target task, an operation interface related to the first task is presented in the second region of the first page while maintaining presentation of the guidance information.

In this way, the guidance information related to the task is presented through the selection of the task scenario, and while displaying of the guidance information display is still maintained after a certain task is selected, the related operation interface of the selected task is presented, thereby facilitating the user to know the task to be executed and how to trigger and execute the task to be executed. This brings convenience for the user to find, position, and execute the task, facilitates to improve the task execution efficiency for the user, and effectively improves the user experience.

Some example embodiments of the disclosure will be described below with continued reference to the accompanying drawings. It should be understood that pages shown in the drawings are merely examples, and there actually may be various page designs. Various graphical elements in the page may have different arrangements and different visual representations, one or more elements thereof may be omitted or replaced, and one or more other elements may also be present. Embodiments of the disclosure are not limited in this regard.

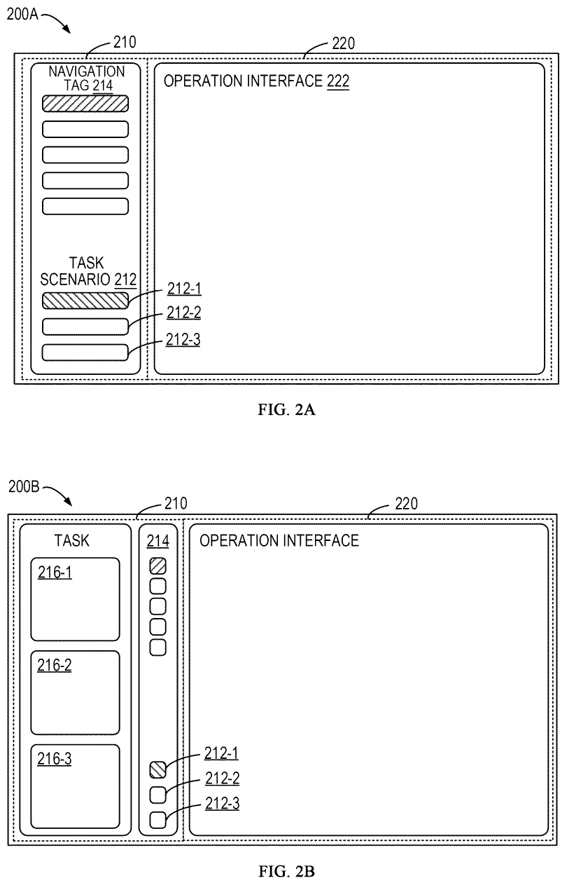

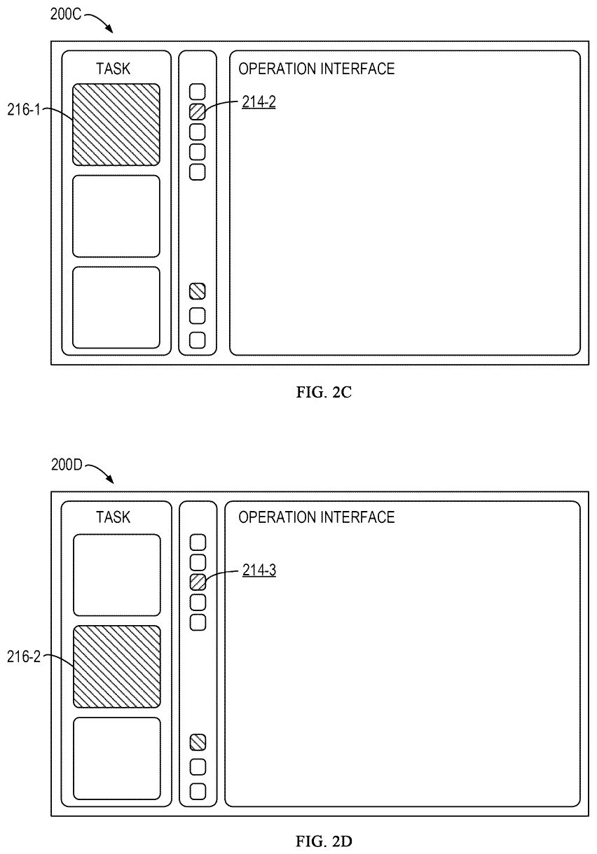

FIGS. 2A-2D illustrate example pages 200A-200D according to some embodiments of the disclosure. For ease of discussion, the pages 200A-200D will be described with reference to the environment 100 of FIG. 1. The pages 200A-200D may be provided by the electronic device 110 shown in FIG. 1. The pages 200A-200D may be example structures presented on a first page in the application 120 based on the interaction between the user 140 and the application 120. As an example, the first page may be any suitable page that the application 120 may provide.

As shown in FIG. 2A, the electronic device 110 presents an indication of the at least one task scenario 212 in the first region 210 of the first page. As an example, the first region 210 may be a region where a navigation bar of the application 120 is located. The navigation bar may aggregates one or more interface elements, such as tag(s), button(s), control(s) and the like to support switching and browsing between different blocks, content areas, or functional modules of the application 120 by the user.

As an example, each task scenario 212 may be a scenario for executing a certain task item in the application 120. Taking three task scenarios 212 in FIG. 2A as an example, the three task scenarios 212 may be used to implement a task item of “annotate data” in the application 120, a task item of “register algorithms”, and a task item of “manage rules”, respectively. It should be understood that this is merely an example, and the number of task scenarios 212 and the task items specifically used for implementation are not limited in the application 120.

Here, each of the task scenarios 212 includes at least one task that is executable in the application 120. The execution of each task is based on at least one function provided by the application 120. That is, under each task scenario 212, there may be at least one task to be performed for a corresponding task item. It is assumed that a task scenario 212 is “annotate data”, the task scenario 212 may include, for example, tasks of “prepare tag”, “create dataset”, “create annotation task”, and the like. Accordingly, the execution of these tasks may be based on a function of preparing a tag, a function of creating dataset, a function of creating an annotation task, and the like, provided by the application 120 respectively.

In some embodiments, the indication of the at least one task scenario 212 may include a scenario guidance control corresponding to each of the at least one task scenario 212. Taking the three task scenarios 212 in FIG. 2A as an example, the scenario guidance controls corresponding to the three task scenarios 212 may be, for example, a control 212-1, a control 212-2, and a control 212-3. It should be understood that the indication of each task scenario 212 may further include a name, an image identifier, a symbol, and the like of the task scenario, for example, which is not limited herein.

In some embodiments, at least one navigation tag 214 in the application 120 may also be presented in the first region 210. For example, in FIG. 2A, five navigation tags 214 in the application 120 are presented in the first region 210. It should be understood that the number of the navigation tag 214 in the first region 210 and a tag pattern thereof may be set according to a specific actual situation, which is not limited herein. Generally, the navigation tag may correspond to an entity in the application, and accordingly, the list page of a corresponding instance may be located through the navigation tag.

With continued reference to FIG. 2, the page 200A further includes a second region 220. The second region 220 may be used to present an operation interface 222 located through the navigation tag 214.

In some embodiments, the electronic device 110 may receive a selection of the target task scenario from the at least one task scenario 212 by receiving a trigger for an indication of the target task scenario in the indication of the at least one task scenario 212. The trigger for the indication of the target task scenario may include, for example, a trigger operation on the scenario guidance control corresponding to the target task scenario. The trigger or trigger operation discussed herein may include any suitable type of operation, such as a click operation, a long-press operation, a sliding operation, or the like.

The embodiments of the disclosure will be further discussed below by taking the task scenario of “annotate data” corresponding to the scenario guidance control 212-1 as a target task scenario as an example.

Further, if the selection of the target task scenario from the at least one task scenario 212 is received, the electronic device 110 presents the guidance information corresponding to the at least one target task included in the target task scenario in the first region 210. Referring to FIG. 2B, taking the target task scenario including three target tasks as an example, the guidance information corresponding to respective target tasks may be respectively presented in a sub-region 216-1, a sub-region 216-2, and a sub-region 216-3. It should be understood that the number of sub-regions of the guidance information of the target task presented in the first region 210 may be set according to requirements of an actual task scenario, which is not intended to be limited herein.

In some embodiments, the guidance information included in each task scenario 212 may include at least one of: a name of the task, an execution order of a plurality of tasks, description information of the task(s), and an execution entry of the task(s). It should be understood that the guidance information of each task scenario 212 may further include other suitable information for guiding execution of the task. As an example, more detailed information corresponding to the task may be expanded by triggering an execution entry of the task. More specific information presented after the execution entry of the trigger task is discussed in detail below.

In some embodiments, the at least one target task may include a plurality of target tasks, and the guidance information of the plurality of target tasks in the first region 210 may be arranged in an order of execution of the plurality of target tasks. For example, in FIG. 2B, the guidance information of the plurality of target tasks may be arranged in an order from top to bottom. In other examples, the plurality of target tasks may be appropriately arranged, for example, from left to right, depending on factors such as a style of the first region 210, an amount of content of the guidance information of each of the target tasks, and the like. In this way, the user may obtain the tasks that need to be completed in the corresponding task scenario and the ordering between the tasks, which facilitates the user to operate the application according to requirements, thereby facilitating to improve the user experience.

In some embodiments, when the guidance information corresponding to the at least one target task included in the target task scenario is presented in the first region 210, if the trigger for the scenario guidance control corresponding to the target task scenario is received, the electronic device 110 may control the first region 210 to be in an unfolded state to at least present the guidance information corresponding to the at least one target task in the first region 210. In addition, in some embodiments, if the trigger for the scenario guidance control corresponding to the target task scenario is received, the electronic device 110 may control the scenario guidance control corresponding to the respective task scenario of the at least one task scenario 212 to be in a contracted state. Accordingly, the electronic device 110 may further control the at least one navigation tag 214 to be in a contracted state.

Thus, when the first region 210 is controlled to be in the unfolded state, controlling the contraction of the scenario guidance control and the navigation tag facilitates to provide more presentation areas for the guidance information of the target task. In other embodiments, the guidance information may be hidden when the first region 210 is in a folded state. By folding the first region 210, the user can focus on the specific operation content on the operation interface. The first region 210 is in a unfolded state or a folded state may sometimes be referred to as a state in which a navigation bar is unfolded or in which the navigation bar is folded.

Further, if the selection of the first task from the at least one target task is received, the electronic device 110 presents an operation interface related to the first task in the second region 220 of the first page while maintaining the presentation of the guidance information. Specifically, the electronic device 110 presents the operation interface related to the first task in the second region 220 while maintaining the presentation of the navigation bar. As an example, the electronic device 110 may determine the selection of the first task by receiving a trigger for an execution entry of the first task in the presented guidance information.

In a conventional solution, an explanation and an entry of various functions of the application are given in a description page of the application, and after the user clicks the entry of a certain function, the corresponding function page is directly jumped to. However, in the embodiments of the disclosure, the presentation of the guidance information may be continuously maintained, so that the user may continue to select the next task to be executed, thereby facilitating the user to perform each of the tasks.

In some embodiments, the operation interface 222 related to each task included in the at least one task scenario 212 is located via a corresponding navigation tag 214. That is, one or more operation interfaces related to each task may be associated with a corresponding entity. For example, when the operation interface is presented in the process of executing the task, the navigation tag corresponding to the operation interface is automatically enabled to be in a selected state. The navigation tag in the selected state may be highlighted, for example.

In some embodiments, if the selection of the first task from the at least one target task is received, the electronic device 110 may cause the navigation tag of the at least one navigation tag corresponding to the first task to be in the selected state. That is, if a task in the at least one target task is selected, a corresponding navigation tag may be in a selected state. This embodiment will be further discussed below in conjunction with the examples of FIGS. 2C and 2D.

Referring to FIG. 2C, if a selection of the task corresponding to the sub-region 216-1 is received, a corresponding navigation tag 214-2 may be in the selected state. Referring further to FIG. 2D, if a selection of the task corresponding to the sub-region 216-2 is received, a corresponding navigation tag 214-3 may be in the selected state. Thus, a secondary organization of the entity of the application may be implemented through the at least one task scenario 212, and a control operation on the entity is implemented by the operation of the guidance information.

According to the embodiment of the disclosure, the guidance information related to the task is presented through a selection of the task scenario, so that the user can conveniently concerns about all tasks in the task scenario, and thus the task to be executed is located. The relevant operation interface of the selected task is presented while maintaining the display of the guidance information after a certain task is selected, so that the user can also find and locate other tasks to be executed while executing the selected task. This facilitates to improve the user's task execution efficiency.

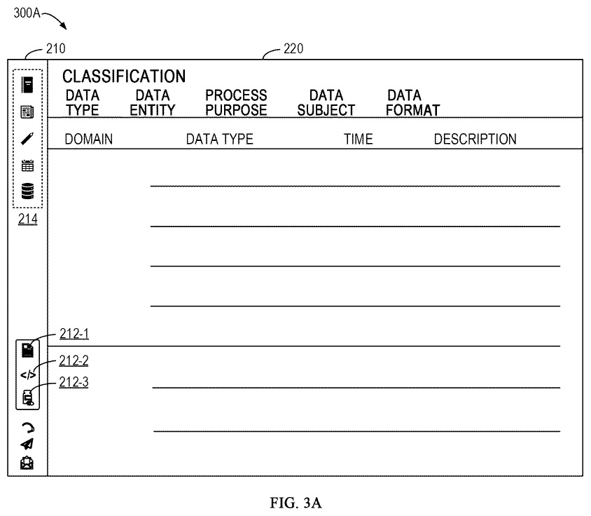

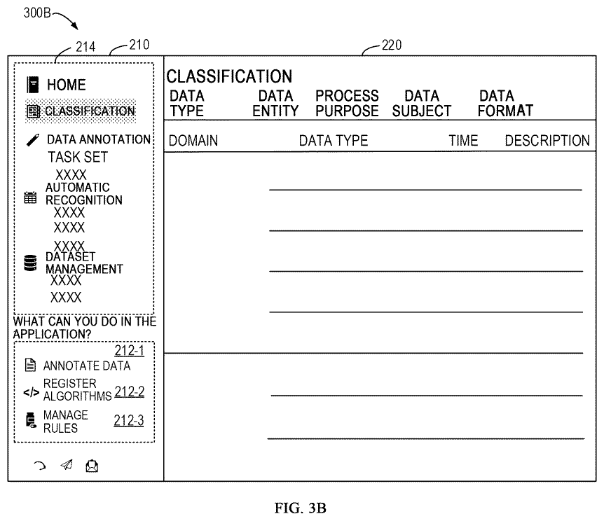

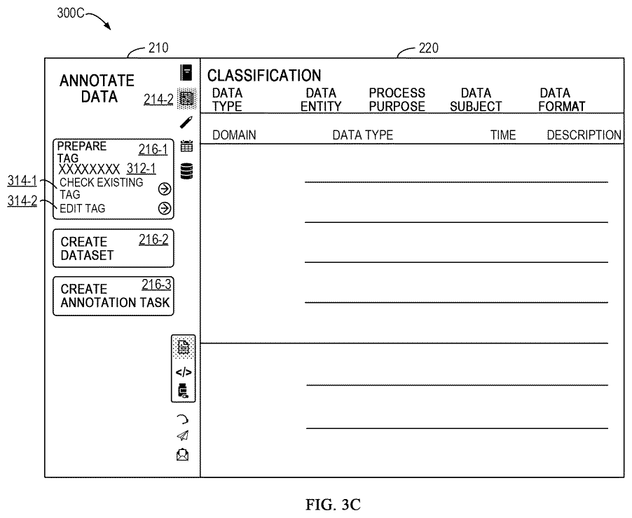

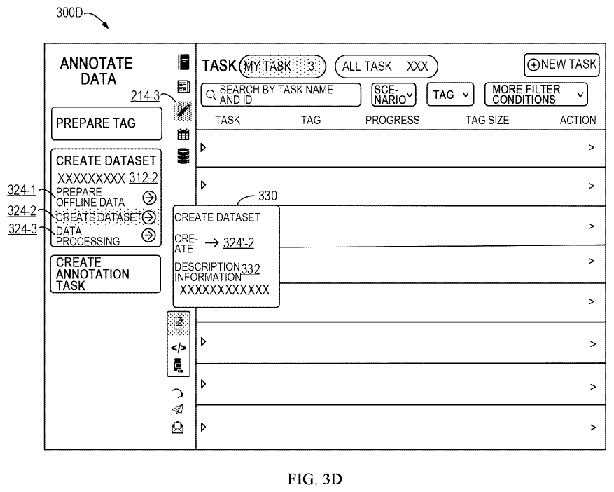

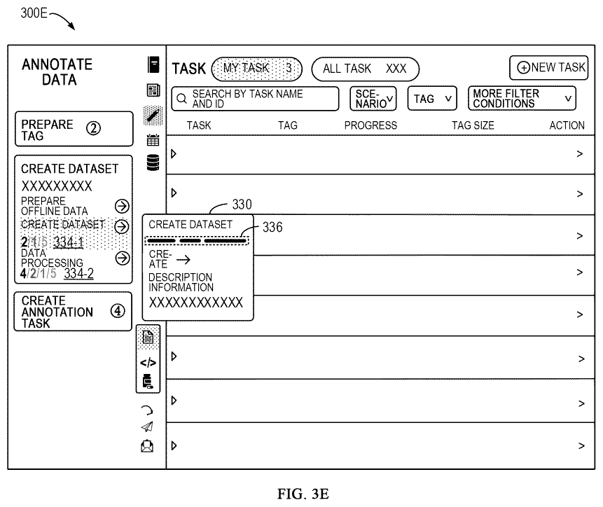

Specific presentation content and corresponding executable operations of example pages 200A-200D will be discussed in detail below in conjunction with FIGS. 3A-3E.

FIGS. 3A-3E illustrate example interfaces 300A-300E according to some embodiments of the disclosure. The interfaces 300A-300E may be provided by the electronic device 110 shown in FIG. 1. The interface 300B may be an example interface of the page 200A, the interface 300C may be an example interface of the page 200C, the interface 300D and the interface 300E may be example interfaces of the page 300D. It should be understood that interfaces 300A-300E are merely examples, and actually, there may be various interface designs. various elements in the interface may have different arrangements and different visual representations, one or more elements thereof may be omitted or replaced, and one or more other elements may also be present. Embodiments of the disclosure are not limited in this regard. In the interfaces 300A-300E, the electronic device 110 may be configured for interaction by receiving the operation of the associated user 140 to present a corresponding interaction result.

Referring to FIG. 3A, in a state where the first region 210 is in the folded state, that is, the navigation bar is folded, both the navigation tag 214 and the scenario guidance control (for example, the controls 212-1 to 212-3) may be in the contracted state. Referring further to FIG. 3B, the navigation bar may be in another unfolded state, for example, the navigation tag 214 and the scenario guidance control (e.g., controls 212-1 to 212-3) are both in the unfolded state. It should be noted that, in the unfolded state, the electronic device 110 does not receive the trigger operation on the scenario guidance control.

In some embodiments, if a selection of a task from the at least one target task is received, the electronic device 110 may present more specific at least one information about the task in the first region 210. The more specific information of the task will be discussed in detail below in conjunction with FIGS. 3C-3E.

In some embodiments, if the selection of a first task from the at least one target task is received, the electronic device 110 may present description information of the first task in the first region 210. The description information may include, for example, information such as a purpose to be executed by the task, a function that can be implemented, and the like, which is not limited herein.

Referring to FIG. 3C, if the selection of the task corresponding to sub-region 216-1 (e.g., a task of “prepare tag”) is received, corresponding description information 312-1 may be presented in sub-region 216-1. Referring further to FIG. 3D, if a selection of a task corresponding to sub-region 216-2 (e.g., a task of “create dataset”) is received, corresponding description information 312-2 may be presented in the sub-region 216-2.

Alternatively or additionally, in some embodiments, if the selection of the first task from the at least one target task is received, an indication of at least one sub-task included in the first task and/or an execution entry corresponding to each sub-task may be presented in the first region 210.

Here, each task may include at least one sub-task. In some embodiments, the at least one sub-task may correspond to at least one function provided by the execution of each task by the application 120 discussed above, respectively. For example, referring to FIG. 3C, for the task of “prepare tag,” its sub-task may include, for example, a sub-task of “check existing tag”, which may correspond to a function of checking an existing tag provided by the application. For the task of “prepare tag”, its sub-task may also include, for example, a sub-task of “edit tag”, which may correspond to a function of editing a tag provided by the application. It should be understood that this is not intended to limit the number of sub-tasks per task and the functionality that each sub-task can implement.

As an example, the indication of the sub-task may include at least a name of the sub-task. For example, for the “prepare tag” task, an indication of its sub-task may include, for example, a name “check existing tag”, a name “edit tag”, and the like. The indication of the sub-task may also include any suitable image-text characters, identifiers, and the like that may indicate the sub-task, which is not limited herein. As an example, a plurality of sub-tasks of the selected task may be arranged according to the execution order of the plurality of sub-tasks to facilitate the user 140 to know the execution order of the sub-tasks in the task. For example, with respect to the “prepare tag” task, it may be arranged in an order of “check existing tag” sub-task and “edit tag” sub-task from top to bottom. It should be understood that, for an arrangement manner such as from top to bottom or from left to right, it is not limited herein, and may be set according to a style and layout of the sub-region in which it is located.

As an example, the execution entry of the sub-task may be used as a starting entry for execution of the sub-task. In FIG. 3C, execution entries corresponding to a plurality of sub-tasks of the “prepare tag” task may include, for example, an entry 314-1 and an entry 314-2. The entry 314-1 and the entry 314-2 may be used to receive a trigger of the user 140 to initiate execution of the “check existing tag” sub-task and the “edit tag” sub-task, respectively.

Referring to FIG. 3D, execution entries corresponding to a plurality of sub-tasks of the “create dataset” task may include, for example, an entry 324-1, an entry 324-2, and an entry 324-3. The entry 324-1, the entry 324-2, and the entry 324-3 may be used to receive a trigger of the user 140 to initiate execution of a “prepare offline data” sub-task, a “create dataset” sub-task, and a “data processing” sub-task, respectively.

In some embodiments, if a predetermined operation corresponding to a second sub-task in the at least one sub-task is received, the electronic device 110 may present a predetermined panel near an execution entry corresponding to the second sub-task. The panel may include an execution entry and description information for the second sub-task. Here, the user 140 performs a predetermined operation on each of the at least one sub-task, and the corresponding panel is presented for providing more detailed information about the sub-task. As an example, the predetermined operation may include, for example, a long-press operation, a mouse-based hover operation, a click operation, and the like, which is not limited herein.

Taking the interface 300D as an example, assuming that the electronic device 110 receives a predetermined operation on a certain sub-task (for example, the “create dataset” sub-task) in the “create dataset” task, the panel 330 may be presented near the execution entry 324-2 of the sub-task. The panel 330 may include description information 332 and an execution entry 324′-2 for the sub-task. The description information 332 of the sub-task may include, for example, information such as a purpose to be performed by the sub-task, a specific function that can be implemented, and the like, which is not limited herein. It should be noted that execution of the “create dataset” sub-task may be initiated by triggering the execution entry 324-2 of the “create dataset” sub-task and the execution entry 324′-2 of the sub-task on the panel 330.

Alternatively or additionally, in some embodiments, if the selection of the first task from the at least one target task is received, a completion progress of the first task may be presented in the first region 210. As an example, several sub-tasks of each task may have respective completion progresses, but for one task, the completion progress of each sub-task also constitutes the completion progress of the task. For example, assuming that a task has five (or other number of) sub-tasks, where three (or other number of) sub-tasks have been completed, may be marked with a tick or as a completed state, which also represents that the completion progress of this task is 60% (or in other proportion).

Referring to FIG. 3E, taking the interface 300E as an example, the interface 300E shows a progress indication 334-1 of the “create dataset” sub-task and a progress indication 334-2 of the “data processing” sub-task. The “prepare offline data” sub-task may not need a progress indication, depending on the specific requirements. It should be understood that a specific style of the progress indication of the sub-task is not limited. In addition, in the panel of the sub-task, the completion progress of the sub-task may be displayed through a more intuitive progress bar. For example, in the panel 330, the completion progress of the “create dataset” sub-task may be displayed by the progress bar 336.

As another example, a task execution state of the task may also be directly displayed in the sub-region of each task, and the task execution state may indicate a task execution progress task. The execution state may include, for example, a completed state, an incomplete state, in a completion of 50% (or in other proportion), in a completion of has ⅓ (or other proportion), and the like. Through the presentation of the execution state, the execution progress and the like of the task or sub-task, the user 140 can conveniently know the completion status of the task or sub-task, which is beneficial to improving the user experience.

In some embodiments, when the operation interface related to the first task is presented in the second region 220 of the first page, if a trigger for a first execution entry of a first sub-task of the at least one sub-task is received, the electronic device 110 may present an operation interface related to the first sub-task in the second region 220 of the first page while maintaining the presentation of the guidance information. As an example, the sub-task related operation interface to be presented may depend on a function to be implemented by the corresponding execution entry. For example, if the sub-task is to create an interface, the interface may be directly created after the corresponding execution entry is triggered. If the sub-task is to prepare offline data, a default home page of the sub-task may be presented after the corresponding execution entry is triggered. If the sub-task is data processing, an interface leaving from after the sub-task is operated last time may be presented after the corresponding execution entry is triggered.

As an example, the operation interface related to each sub-task may be located via a corresponding navigation tag. That is, each sub-task may also be associated with the corresponding navigation tag. In some embodiments, if the trigger for the first execution entry of the first sub-task of the at least one sub-task is received, the electronic device 110 may cause a navigation tag of at least one navigation tag 214 corresponding to the first sub-task to be in a selected state. The related operation interface presented by the sub-task may be associated with an entity corresponding to the selected navigation tag.

Thus, the task and the sub-task may be respectively associated with an entity corresponding to the navigation tag, thereby implementing secondary organization of the entity of the application through the task scenario, and control operations on the entity.

In some embodiments, if switching from the first task to a second task in the at least one target task or a further task scenario in the at least one task scenario 212 is received, the electronic device 110 may present an operation interface associated with a task included in the second task or the further task scenario in the second region 220. That is, the user 140 may switch tasks arbitrarily or switch from one task scenario to another task scenario. If a new task scenario is switched to, the second region 220 may present an operation interface corresponding to a task ordered in a first place in the new task scenario. It should be understood that the presented operation interface may be specifically set according to actual setting, which is not intended to be limited herein.

According to the embodiment of the disclosure, the guidance information related to the task is presented through the selection of the task scenario, and the related operation interface of the selected task is presented while maintaining the display of the guidance information after a certain task is selected, so that the user can conveniently know the task to be executed and how to trigger execution of the task to be executed. This brings convenience to the user for finding tasks, locating tasks and executing tasks, and effectively improves the user experience. In addition, the secondary organization and control operation of the entity of the application is realized through the task scenario.

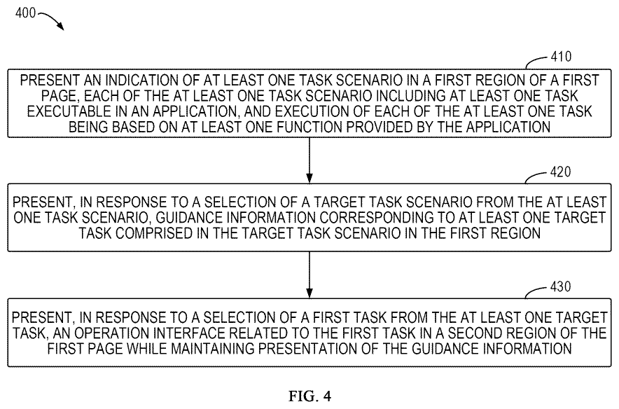

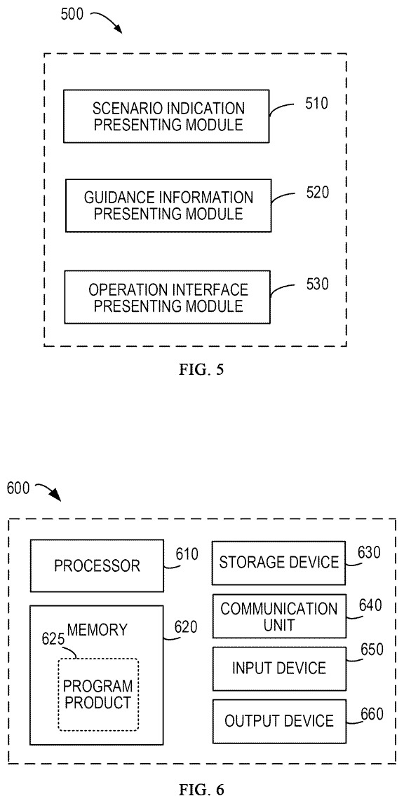

FIG. 4 illustrates a flowchart of an interactive example process 400 according to some embodiments of the disclosure. The process 400 may be implemented at the electronic device 110 in FIG. 1. The process 400 is described below with reference to FIG. 1.

As shown, at block 410, an indication of at least one task scenario is presented in a first region of a first page, each of the at least one task scenario including at least one task executable in an application, and execution of each task is based on at least one function provided by the application.

At block 420, in response to a selection of a target task scenario from the at least one task scenario, guidance information corresponding to at least one target task included in the target task scenario is presented in the first region.

At block 430, in response to a selection of a first task from the at least one target task, an operation interface related to the first task is presented in a second region of the first page while maintaining presentation of the guidance information.

In some embodiments, at least one navigation tag in the application is also presented in the first region, and an operation interface associated with each task included in the at least one task scenario is located via a corresponding navigation tag.

In some embodiments, the process 400 further includes: causing a navigation tag of the at least one navigation tag corresponding to the first task to be in a selected state in response to a selection of the first task from the at least one target task.

In some embodiments, the indication of the at least one task scenario includes a scenario guidance control corresponding to each of the at least one task scenario, and presenting the guidance information corresponding to the at least one target task included in the target task scenario in the first region includes: in response to receiving a trigger for the scenario guidance control corresponding to the target task scenario, controlling the first region to be in an unfolded state to at least present the guidance information corresponding to the at least one target task in the first region.

In some embodiments, the process 400 further includes: presenting, in response to a selection of the first task from the at least one target task, at least one of the following in the first region: description information of the first task, a completion progress of the first task, an indication of at least one sub-task included in the first task, or an execution entry corresponding to each sub-task.

In some embodiments, presenting the operation interface related to the first task in the second region of the first page includes: presenting, in response to a trigger for the first execution entry of a first sub-task of the at least one sub-task, an operation interface related to the first sub-task in the second region of the first page while maintaining the presentation of the guidance information.

In some embodiments, the process 400 further includes: presenting, in response to a predetermined operation corresponding to a second sub-task of the at least one sub-task, a predetermined panel near an execution entry corresponding to the second sub-task, the panel including the execution entry and description information of the second sub-task.

In some embodiments, the at least one target task includes a plurality of target tasks, and respective guidance information of the plurality of target tasks in the first region is arranged in an order of execution of the plurality of target tasks.

In some embodiments, the process 400 further includes: presenting, in response to switching from the first task to a second task in the at least one target task or a further task scenario in the at least one task scenario, an operation interface associated with a task included in the second task or the further task scenario in the second region.

Embodiments of the disclosure also provide a corresponding apparatus for implementing the above method or process. FIG. 4 shows a schematic structural block diagram of an example apparatus 500 for task navigation according to some embodiments of the disclosure. The apparatus 500 may be implemented or included in a terminal device 120. Various modules/components in the apparatus 500 may be implemented by hardware, software, firmware, or any combination thereof.

As shown, the apparatus 500 includes a scenario indication presenting module 510 configured to present an indication of at least one task scenario in a first region of a first page, each of the at least one task scenario including at least one task executable in an application, and execution of each of the at least one task being based on at least one function provided by an application; a guidance information presenting module 520 configured to present, in response to a selection of a target task scenario from the at least one task scenario, guidance information corresponding to at least one target task included in the target task scenario in the first region; and an operation interface presenting module 530 configured to present, in response to a selection of a first task from the at least one target task, an operation interface related to the first task in a second region of the first page while maintaining presentation of the guidance information.

In some embodiments, at least one navigation tag in the application is also presented in the first region, and an operation interface associated with each task included in the at least one task scenario is located via a corresponding navigation tag.

In some embodiments, the apparatus 500 further includes a navigation tag selection module configured to cause a navigation tag of the at least one navigation tag corresponding to the first task to be in the selected state in response to a selection of the first task from the at least one target task.

In some embodiments, the indication of the at least one task scenario includes a scenario guidance control corresponding to each of the at least one task scenario, and the guidance information presenting module 520 is further configured to, in response to receiving a trigger for the scenario guidance control corresponding to the target task scenario, control the first region to be in an unfolded state to at least present guidance information corresponding to the at least one target task in the first region.

In some embodiments, the apparatus 500 further includes a first region presenting module configured to present, in response to a selection of the first task from the at least one target task, at least one of the following in the first region: description information of the first task, a completion progress of the first task, an indication of at least one sub-task included in the first task, or an execution entry corresponding to each sub-task.

In some embodiments, the operation interface presenting module 530 is further configured to present, in response to a trigger for the first execution entry of a first sub-task of the at least one sub-task, an operation interface related to the first sub-task in the second region of the first page while maintaining the presentation of the guidance information.

In some embodiments, the apparatus 500 further includes a panel presenting module configured to present, in response to a predetermined operation corresponding to a second sub-task of the at least one sub-task, a predetermined panel near an execution entry corresponding to the second sub-task, the panel including an execution entry description and information of the second sub-task.

In some embodiments, the at least one target task includes a plurality of target tasks, and respective guidance information of the plurality of target tasks in the first region is arranged in an order of execution of the plurality of target tasks.

In some embodiments, the apparatus 500 further includes a switching module configured to present, in response to switching from the first task to a second task in the at least one target task or a further task scenario in the at least one task scenario, an operation interface associated with the task included in the second task or the further task scenario in the second region.

The units and/or modules included in the apparatus 500 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 500 may be implemented at least in part by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 6 illustrates a block diagram of an electronic device 600 in which one or more embodiments of the disclosure may be implemented. It should be understood that the electronic device 600 illustrated in FIG. 6 is merely illustrative and should not constitute any limitation on the functionality and scope of the embodiments described herein. The electronic device 600 shown in FIG. 6 may be configured to implement the electronic device 110 in FIG. 1.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In a multiprocessor system, the plurality of processing units execute computer-executable instructions in parallel to improve the parallel processing capability of the electronic device 600.

The electronic device 600 generally includes a plurality of computer storage media. Such media may be any available media accessible to the electronic device 600, including, but not limited to, volatile and non-volatile media, removable and non-removable media. The memory 620 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 630 may be a removable or non-removable medium and may include a machine-readable medium, such as a flash drive, a magnetic disk, or any other medium, which may be capable of storing information and/or data and may be accessed within the electronic device 600.

The electronic device 600 may further include additional removable/non-removable, volatile/non-volatile storage media/medium. Although not shown in FIG. 6, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the disclosure.

The communication unit 640 implements communication with other electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, the external device, such as a storage device, a display device, or the like, communicates with one or more devices that enable a user to interact with the electronic device 600, or communicates with any device (e.g., a network card, a modem, etc.) that enables the electronic device 600 to communicate with one or more other electronic devices. Such communication may be performed via an input/output (I/O) interface (not shown).

According to example implementations of the disclosure, there is provided a computer-readable storage medium having computer-executable instructions stored thereon, and the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowchart and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for task navigation, comprising:
presenting an indication of at least one task scenario in a first region of a first page, each of the at least one task scenario comprising at least one task executable in an application, and execution of each of the at least one task being based on at least one function provided by the application;
presenting, in response to a selection of a target task scenario from the at least one task scenario, guidance information corresponding to at least one target task comprised in the target task scenario in the first region; and
presenting, in response to a selection of a first task from the at least one target task, an operation interface related to the first task in a second region of the first page while maintaining presentation of the guidance information.

2. The method of claim 1, wherein at least one navigation tag in the application is also presented in the first region, and an operation interface associated with each task comprised in the at least one task scenario is located via a corresponding navigation tag.

3. The method of claim 2, further comprising:
causing a navigation tag of the at least one navigation tag corresponding to the first task to be in a selected state in response to a selection of the first task from the at least one target task.

4. The method of claim 1, wherein the indication of the at least one task scenario comprises a scenario guidance control corresponding to each of the at least one task scenario, and
wherein presenting the guidance information corresponding to the at least one target task comprised in the target task scenario in the first region comprises:
controlling the first region to be in an unfolded state to at least present the guidance information corresponding to the at least one target task in the first region, in response to receiving a trigger for the scenario guidance control corresponding to the target task scenario.

5. The method of claim 1, further comprising:
presenting, in response to a selection of the first task from the at least one target task, at least one of the following in the first region:
description information of the first task,
a completion progress of the first task,
an indication of at least one sub-task comprised in the first task, or
an execution entry corresponding to each sub-task.

6. The method of claim 5, wherein presenting the operation interface related to the first task in the second region of the first page comprises:
presenting, in response to a trigger for a first execution entry of a first sub-task of the at least one sub-task, an operation interface related to the first sub-task in the second region of the first page while maintaining the presentation of the guidance information.

7. The method of claim 5, further comprising:
presenting, in response to a predetermined operation corresponding to a second sub-task in the at least one sub-task, a predetermined panel near an execution entry corresponding to the second sub-task, the panel comprising the execution entry and description information of the second sub-task.

8. The method of claim 1, wherein the at least one target task comprises a plurality of target tasks, and wherein respective guidance information of the plurality of target tasks in the first region is arranged in an order of execution of the plurality of target tasks.

9. The method of claim 1, further comprising:
presenting, in response to switching from the first task to a second task in the at least one target task or to a further task scenario in the at least one task scenario, an operation interface associated with a task comprised in the second task or the further task scenario in the second region.

11. An electronic device, comprising:
at least one processor; and
at least one memory coupled to the at least one processor and storing instructions for execution by the at least one processor,
wherein the instructions, when executed by the at least one processor, cause the electronic device to perform acts comprising:
presenting an indication of at least one task scenario in a first region of a first page, each of the at least one task scenario comprising at least one task executable in an application, and execution of each of the at least one task being based on at least one function provided by the application;
presenting, in response to a selection of a target task scenario from the at least one task scenario, guidance information corresponding to at least one target task comprised in the target task scenario in the first region; and
presenting, in response to a selection of a first task from the at least one target task, an operation interface related to the first task in a second region of the first page while maintaining presentation of the guidance information.

12. The electronic device of claim 11, wherein at least one navigation tag in the application is also presented in the first region, and an operation interface associated with each task comprised in the at least one task scenario is located via a corresponding navigation tag.

13. The electronic device of claim 12, wherein the acts further comprise:
causing a navigation tag of the at least one navigation tag corresponding to the first task to be in a selected state in response to a selection of the first task from the at least one target task.

14. The electronic device of claim 11, wherein the indication of the at least one task scenario comprises a scenario guidance control corresponding to each of the at least one task scenario, and
wherein presenting the guidance information corresponding to the at least one target task comprised in the target task scenario in the first region comprises:
controlling the first region to be in an unfolded state to at least present the guidance information corresponding to the at least one target task in the first region, in response to receiving a trigger for the scenario guidance control corresponding to the target task scenario.

15. The electronic device of claim 11, wherein the acts further comprise:
presenting, in response to a selection of the first task from the at least one target task, at least one of the following in the first region:
description information of the first task,
a completion progress of the first task,
an indication of at least one sub-task comprised in the first task, or
an execution entry corresponding to each sub-task.

16. The electronic device of claim 15, wherein presenting the operation interface related to the first task in the second region of the first page comprises:
presenting, in response to a trigger for a first execution entry of a first sub-task of the at least one sub-task, an operation interface related to the first sub-task in the second region of the first page while maintaining the presentation of the guidance information.

17. The electronic device of claim 15, wherein the acts further comprise:
presenting, in response to a predetermined operation corresponding to a second sub-task in the at least one sub-task, a predetermined panel near an execution entry corresponding to the second sub-task, the panel comprising the execution entry and description information of the second sub-task.

18. The electronic device of claim 11, wherein the at least one target task comprises a plurality of target tasks, and wherein respective guidance information of the plurality of target tasks in the first region is arranged in an order of execution of the plurality of target tasks.

19. The electronic device of claim 11, wherein the acts further comprise:
presenting, in response to switching from the first task to a second task in the at least one target task or to a further task scenario in the at least one task scenario, an operation interface associated with a task comprised in the second task or the further task scenario in the second region.

20. A non-transitory computer-readable storage medium having a computer program stored thereon which is executable by a processor to implement acts comprising:
presenting an indication of at least one task scenario in a first region of a first page, each of the at least one task scenario comprising at least one task executable in an application, and execution of each of the at least one task being based on at least one function provided by the application;
presenting, in response to a selection of a target task scenario from the at least one task scenario, guidance information corresponding to at least one target task comprised in the target task scenario in the first region; and
presenting, in response to a selection of a first task from the at least one target task, an operation interface related to the first task in a second region of the first page while maintaining presentation of the guidance information.
